(19) United States
(12) Patent Application Publication
(10) Pub. No.: US 2007/0046606 A1
(43) Pub. Date: Mar. 1, 2007

(54) Liquid crystal display device, module for driving the same and method of driving the same

(76) Inventors: Il-Gon Kim, Seoul (KR); Ung-Sik Kim, Suwon-si (KR); Tae-Hyeong Park, Yongin-si (KR); Kook-Chul Moon, Yongin-si (KR); Pil-Mo Choi, Seoul (KR); Seock-Cheon Song, Yeongtong-dong (KR); Sang-Hoon Lee, Seoul (KR); Keun-Woo Park, Seoul (KR); Ho-Suk Maeng, Seoul (KR)

Correspondence Address: CANTOR COLBURN, LLP, 55 GRIFFIN ROAD SOUTH, BLOOMFIELD, CT, 06002, US

(21) Appl. No.: 11/507,723

(22) Filed: Aug. 22, 2006

(30) Foreign Application Priority Data
Aug. 30, 2005 (KR) 2005-79919
Sep. 26, 2005 (KR) 2005-89114

(51) Int. Cl. G09G 3/36

(52) U.S. Cl. 345/90

(57) ABSTRACT

A liquid crystal display (“LCD”) device includes an LCD panel and a driving module. The LCD panel includes a plurality of pixel parts, each including a transmitting portion and a reflecting portion. The transmitting portion has a first switching element electrically connected to a first gate line, and a first liquid crystal capacitor electrically connected to the first switching element. The reflecting portion has a second switching element electrically connected to a second gate line, and a second liquid crystal capacitor electrically connected to the second switching element. The driving module applies a first common voltage to the first liquid crystal capacitor during turning-on of the first switching element, and applies a second common voltage to the second liquid crystal capacitor during turning-on of the second switching element. Therefore, an image display quality is improved.

The present application claims priority to Korean Patent Application No. 2005-79919, filed on Aug. 30, 2005, and Korean Patent Application No. 2005-89114, filed on Sep. 26, 2005 and all the benefits accruing therefrom under 35 U.S.C. §119, and the contents of which in their entireties are herein incorporated by reference.

### BACKGROUND OF THE INVENTION

1. Field of the Invention

The present invention relates to a liquid crystal display (“LCD”) device, a module for driving the LCD device, and a method of driving the LCD device. More particularly, the present invention relates to an LCD device capable of improving an image display quality, a module for driving the LCD device, and a method of driving the LCD device.

2. Description of the Related Art

A liquid crystal display (“LCD”) device includes an LCD panel having a lower substrate, an upper substrate, and a liquid crystal layer interposed between the lower and upper substrates. Liquid crystals of the liquid crystal layer vary arrangement in response to an electric field applied thereto, and thus a light transmittance of the liquid crystal layer is changed, thereby displaying an image.

The LCD panel is classified into a reflective LCD panel, a transmissive LCD panel, and a transflective LCD panel based on a light source. In the reflective LCD panel, externally provided light is reflected from the reflective LCD panel to display the image. In the transmissive LCD panel, internally provided light that is from a rear side of the transmissive LCD panel from a backlight assembly passes through the transmissive LCD panel to display the image. In the transflective LCD panel, the externally provided light is reflected from the transflective LCD panel, and the internally provided light passes through the transflective LCD panel, thereby displaying the image.

In the transflective LCD panel, a voltage-transmittance (“V-T”) curve of a transmission mode is different from a voltage-reflectivity (“V-R”) curve of a reflection mode.

FIG. 1A is a graph illustrating a relationship between a voltage and a transmittance in a vertical alignment (“VA”) mode. FIG. 1B is a graph illustrating a relationship between a voltage and a reflectivity in the VA mode.

Referring to FIGS. 1A and 1B, a black voltage VTb of the transmission mode is substantially the same as a black voltage VRb of the reflection mode. Each of the black voltages VTb and VRb of the transmission and reflection modes is about 0V to about 1.5V. However, a white voltage VTw of the transmission mode is different from a white voltage VRw of the reflection mode. The white voltage VTw of the transmission mode is about 4.5V, while the white voltage VRw of the reflection mode is about 2.5V. A difference between the white voltages VTw and VRw of the transmission and reflection modes is about 2V.

When the transmittance of the V-T curve is different from the reflectivity of the V-R curve, an image display quality of the transflective LCD device is deteriorated.

### BRIEF SUMMARY OF THE INVENTION

The present invention provides a liquid crystal display (“LCD”) device improving an image display quality.

The present invention also provides a module for driving the above-mentioned LCD device.

The present invention also provides a method of driving the above-mentioned LCD device.

An exemplary LCD device in accordance with exemplary embodiments of the present invention includes an LCD panel and a driving module. The LCD panel includes a plurality of pixel parts. Each of the pixel parts includes a transmitting portion and a reflecting portion. The transmitting portion has a first switching element electrically connected to a first gate line, and a first liquid crystal capacitor electrically connected to the first switching element. The reflecting portion has a second switching element electrically connected to a second gate line, and a second liquid crystal capacitor electrically connected to the second switching element. The driving module applies a first common voltage to the first liquid crystal capacitor during turning-on of the first switching element, and applies a second common voltage to the second liquid crystal capacitor during turning-on of the second switching element.

An exemplary LCD device in accordance with other exemplary embodiments of the present invention includes an LCD panel and a driving module. The LCD panel includes a plurality of pixel parts. Each of the pixel parts includes a transmitting portion and a reflecting portion. The transmitting portion has a first switching element electrically connected to a first gate line, and a transmission portion having a first liquid crystal capacitor electrically connected to the first switching element. The reflecting portion has a second switching element electrically connected to a second gate line, and a reflection portion having a second liquid crystal capacitor electrically connected to the second switching element. The driving module applies a first common voltage to the first liquid crystal capacitor during turning-on of the first switching element, and applies a second common voltage to the second liquid crystal capacitor during turning-off of the first switching element and turning-on of the second switching element.

An exemplary driving module for driving an exemplary LCD device including a plurality of pixel parts in accordance with exemplary embodiments of the present invention includes a gate driving unit and a voltage generating unit. Each of the pixel parts includes a transmitting portion having a first switching element electrically connected to a first gate line and a first liquid crystal capacitor electrically connected to the first switching element, and a reflecting portion having a second switching element electrically connected to a second gate line and a second liquid crystal capacitor electrically connected to the second switching element. The gate driving unit outputs a first gate signal and a second gate signal activating the first and second gate lines, respectively. The voltage generating unit applies the first common voltage to the first liquid crystal capacitor during activation of the first gate line, and applies the second common voltage to the second liquid crystal capacitor during a deactivation of the first gate line.

An exemplary method of driving an exemplary LCD device including a pixel part in accordance with exemplary embodiments of the present invention is provided as follows. The pixel part includes a transmitting portion having a first switching element and a first liquid crystal capacitor electrically connected to the first switching element, and a reflecting portion having a second switching element and a second liquid crystal capacitor electrically connected to the second switching element. The first switching element is turned on to charge the first liquid crystal capacitor by a first pixel voltage corresponding to a voltage difference between a data voltage from the first switching element and a first common voltage. The first switching element is turned off, and the second switching element is turned on to charge the second liquid crystal capacitor by a second pixel voltage corresponding to a voltage difference between a data voltage from the second switching element and a second common voltage.

An exemplary method of driving an exemplary LCD device including a pixel part in accordance with other exemplary embodiments of the present invention is provided as follows. The pixel part includes a transmitting portion having a first switching element and a first liquid crystal capacitor electrically connected to the first switching element, and a reflecting portion having a second switching element, a cell capacitor electrically connected to the second switching element and a second liquid crystal capacitor electrically connected to the cell capacitor. The first switching element is turned on to charge the first liquid crystal capacitor by a first pixel voltage corresponding to a voltage difference between a data voltage from the first switching element and a first common voltage. The first switching element is turned off and the second switching element is turned on to charge the second liquid crystal capacitor by a second pixel voltage corresponding to a voltage difference between a data voltage from the second switching element and a second common voltage.

According to the present invention, the first common voltage is applied to the first liquid crystal capacitor of the transmitting portion, and the second common voltage is applied to the second liquid crystal capacitor of the reflecting portion to improve a display quality of an image displayed in the pixel parts.

### BRIEF DESCRIPTION OF THE DRAWINGS

The above and other advantages of the present invention will become more apparent by describing exemplary embodiments thereof with reference to the accompanying drawings, in which:

FIG. 1A is a graph illustrating a relationship between a voltage and a transmittance in a vertical alignment (“VA”) mode;

FIG. 1B is a graph illustrating a relationship between a voltage and a reflectivity in the VA mode;

FIG. 2 is a plan view illustrating an exemplary liquid crystal display (“LCD”) device in accordance with an exemplary embodiment of the present invention;

FIG. 3 is a plan view illustrating a portion of the exemplary LCD panel shown in FIG. 2;

FIG. 4 is a cross-sectional view taken along line I-I′ shown in FIG. 3;

FIG. 5 is a block diagram illustrating an exemplary main driving unit shown in FIG. 2;

FIG. 6 is a block diagram illustrating an exemplary gate circuit unit shown in FIG. 2;

FIG. 7 is a block diagram illustrating an exemplary source driving unit shown in FIG. 5;

FIG. 8 is a timing diagram illustrating an exemplary method of driving an exemplary LCD device using the exemplary source driving unit shown in FIG. 7;

FIG. 9 is a block diagram illustrating an exemplary source driving unit in accordance with another exemplary embodiment of the present invention;

FIG. 10 is a timing diagram illustrating an exemplary method of driving an exemplary LCD device using the exemplary source driving unit shown in FIG. 9;

FIG. 11A is a graph illustrating a V-T curve and a V-R curve of an LCD device of a VA mode, and FIG. 11B is a graph illustrating a V-T curve and a V-R curve of an exemplary LCD device of a VA mode in accordance with another exemplary embodiment of the present invention;

FIG. 12 is a plan view illustrating an exemplary LCD device in accordance with another exemplary embodiment of the present invention;

FIG. 13 is a block diagram illustrating an exemplary main driving unit shown in FIG. 12;

FIG. 14 is a timing diagram illustrating an exemplary method of driving the exemplary LCD device shown in FIG. 12; and

FIG. 15 is a graph illustrating a V-T curve and a V-R curve of an exemplary LCD device in accordance with another exemplary embodiment of the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described with reference to the accompanying drawings.

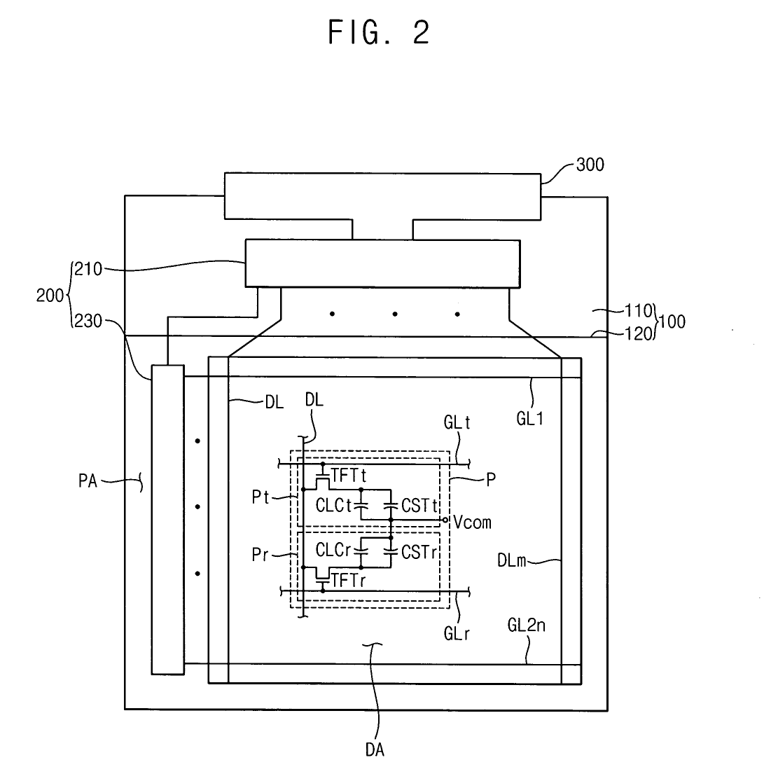

FIG. 2 is a plan view illustrating an exemplary liquid crystal display (“LCD”) device in accordance with an exemplary embodiment of the present invention.

Referring to FIG. 2, the LCD device includes an LCD panel 100, a driving module 200, and a flexible printed circuit board (“FPC”) 300. The driving module 200 is electrically connected to an external module (not shown) through the FPC 300.

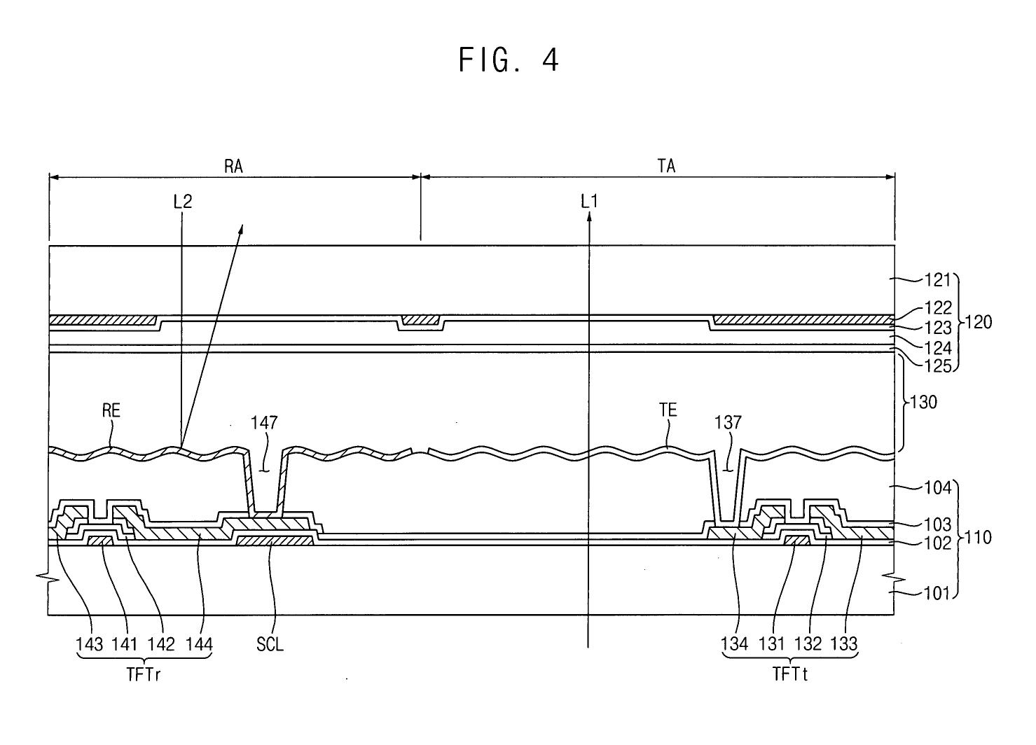

The LCD panel 100 includes a lower substrate 110, an upper substrate 120 and a liquid crystal layer 130 (as shown in FIG. 4). The upper substrate 120 corresponds to the lower substrate 110. The liquid crystal layer 130 is interposed between the lower and upper substrates 110 and 120. The LCD panel 100 includes a display region DA and a peripheral region PA that surrounds the display region DA.

A plurality of source lines DL1, DL2, . . . , DLm, also known as data lines, extending in a first direction from the main driving unit 210, and a plurality of gate lines GL1, GL2, . . . GL2n, also known as scanning lines, extending in a second direction substantially perpendicular to the first direction from the gate circuit unit 230, are formed in the display region DA. The number of the source lines DL1, DL2, . . . , DLm and the number of the gate lines GL1, GL2, . . . , GL2n are ‘m’ and ‘2n’, respectively, where ‘m’ and ‘n’ are natural numbers. A plurality of pixel parts P is defined in the display region DA by the source and gate lines DL1, DL2, . . . , DLm and GL1, GL2, . . . , GL2n in a matrix configuration. The number of the pixel parts P is m×n.

Each of the pixel parts P includes a transmitting portion Pt and a reflecting portion Pr. The transmitting portion Pt and the reflecting portion Pr are defined by two gate lines GLt and GLr and one source line DL. A first light passes through the transmitting portion Pt, such as through the lower and upper substrates 110 and 120. A second light is reflected from the reflecting portion Pr, such as by first passing through the upper substrate 120, and then being reflected back through the upper substrate 120. The transmitting portion Pt includes a first switching element TFTt, a first liquid crystal capacitor CLCt and a first storage capacitor CSTt. The first switching element TFTt may be a thin film transistor (“TFT”). The first switching element TFTt is electrically connected to the source line DL and the first gate line GLt. The first switching element TFTt includes a source electrode connected to the source line DL and a gate electrode connected to the first gate line GLt. The first liquid crystal capacitor CLCt and the first storage capacitor CSTt are electrically connected to the first switching element TFTt. The first switching element TFTt includes a drain electrode for electrically connecting to the first liquid crystal capacitor CLCt.

The reflecting portion Pr includes a second switching element TFTr, a second liquid crystal capacitor CLCr, and a second storage capacitor CSTr. The second switching element TFTr may also be a thin film transistor (“TFT”). The second switching element TFTr is electrically connected to the source line DL and the second gate line GLr. The second switching element TFTr includes a source electrode connected to the source line DL and a gate electrode connected to the second gate line GLr. The second liquid crystal capacitor CLCr and the second storage capacitor CSTr are electrically connected to the second switching element TFTr. The second switching element TFTr includes a drain electrode for electrically connecting to the second liquid crystal capacitor CLCr.

The driving module 200 includes a main driving unit 210 and a gate circuit unit 230.

The main driving unit 210 may include a chip in the peripheral region PA to apply driving signals to the pixel parts P based on control signals and data signals from the FPC 300. The main driving unit 210 may be located on the lower substrate 110.

The gate circuit unit 230 may be integrated onto the peripheral region PA. Alternatively, the gate circuit unit 230 may include a chip in the peripheral region PA. The gate circuit unit 230 applies gate signals G1t, G1r, G2t, G2r, . . . Gnt and Gnr to the gate lines GL1, GL2, . . . , GL2n based on the driving signals from the main driving unit 210. For example, first and second gate signals G1t and G1r of the gate signals G1t, G1r, G2t, G2r, . . . Gnt and Gnr may be applied to the pixel parts P during one horizontal period 1H. For example, the 1H period may be one frame. Alternatively, the 1H period may be an effective display period that is a portion of the frame.

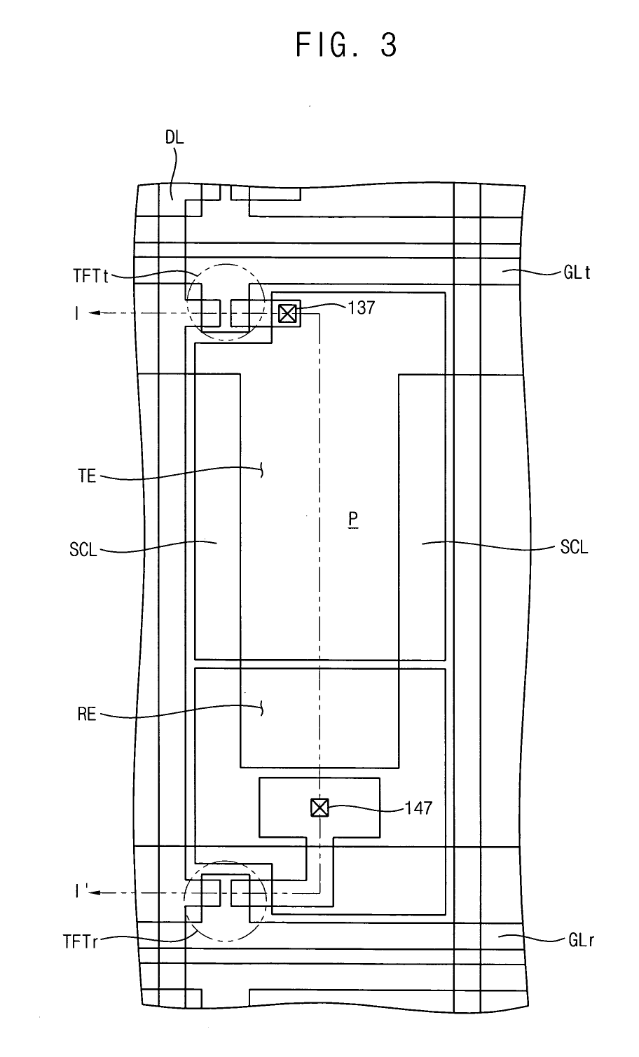

FIG. 3 is a plan view illustrating a portion of the exemplary LCD panel shown in FIG. 2. FIG. 4 is a cross-sectional view taken along line I-I′ shown in FIG. 3.

Referring to FIGS. 2 to 4, the LCD panel includes the lower substrate 110, the upper substrate 120, and the liquid crystal layer 130.

The lower substrate 110 includes a first base substrate 101, including an insulating material such as glass or plastic. The first base substrate 101 includes the pixel parts P defined by the source and gate lines DL1, DL2, . . . , DLm and GL1, GL2, . . . , GL2n. As previously described, the number of the source lines DL1, DL2, . . . , DLm and the number of the gate lines GL1, GL2, . . . , GL2n are ‘m’ and ‘2n’, respectively. The number of the pixel parts P is m×n.

Each of the pixel parts P includes the transmitting portion Pt and the reflecting portion Pr. The first light L1 that is from a rear of the first base substrate 101, such as from a backlight assembly, passes through the transmitting portion Pt in the transmission region TA. The second light L2 that is from a front of the first base substrate 101, such as from a front of the LCD panel 100, is reflected from the reflecting portion Pr in the reflection region RA. A storage common line SCL may also be formed in the pixel parts P.

The transmitting portion Pt includes the first switching element TFTt and a transparent electrode TE. The first switching element TFTt includes a first gate electrode 131, a first source electrode 133, and a first drain electrode 134. The first gate electrode 131 of the first switching element TFTt is electrically connected to the first gate line GLt. The first source electrode 133 of the first switching element TFTt is electrically connected to the source line DL. The first drain electrode 134 of the first switching element TFTt is electrically connected to the transparent electrode TE.

A gate insulating layer 102 is formed on the first gate line GLt and the first gate electrode 131, as well as on exposed portions of the first base substrate 101 and on the second gate line GLr, second gate electrode, and storage common line SCL, as will be further described below. A first active layer 132 is formed on the first gate electrode 131 of the first switching element TFTt between the first source electrode 133 and the first drain electrode 134 of the first switching element TFTt. For example, the first active layer 132 includes amorphous silicon (“a-Si”).

A passivation layer 103 and an organic insulating layer 104 are formed on the source line DL, the first source electrode 133, and the first drain electrode 134, as well as on exposed portions of the gate insulating layer 102, the second source electrode, and the second drain electrode, as will be further described below. The passivation layer 103 and the organic insulating layer 104 include a first contact hole 137 exposing the first drain electrode 134. Alternatively, the organic insulating layer 104 may be omitted. The transparent electrode TE is provided on the organic insulating layer 104, or on the passivation layer 103 if the organic insulating layer 104 is omitted. The first drain electrode 134 is electrically connected to the transparent electrode TE through the first contact hole 137.

The reflecting portion Pr includes the second switching element TFTr and a reflecting electrode RE. The second switching element TFTr includes a second gate electrode 141, a second source electrode 143, and a second drain electrode 144. The second gate electrode 141 of the second switching element TFTr is electrically connected to the second gate line GLr. The second source electrode 143 of the second switching element TFTr is electrically connected to the source line DL. The second drain electrode 144 of the second switching element TFTr is electrically connected to the reflecting electrode RE.

The gate insulating layer 102 is on the second gate line GLr and the second gate electrode 141. A second active layer 142 is formed on the second gate electrode 141 of the second switching element TFTr between the second source electrode 143 and the second drain electrode 144 of the second switching element TFTr. For example, the second active layer 142 includes a-Si.

The passivation layer 103 and the organic insulating layer 104 are formed on the source line DL, the second source electrode 143, and the second drain electrode 144. The passivation layer 103 and the organic insulating layer 104 further include a second contact hole 147 exposing the second drain electrode 144. Alternatively, the organic insulating layer 104 may be omitted. The reflecting electrode RE is provided on the organic insulating layer 104, or on the passivation layer 103 if the organic insulating layer 104 is omitted. The second drain electrode 144 is electrically connected to the reflecting electrode RE through the second contact hole 147.

The storage common line SCL may be formed on the first base substrate 101 from a substantially same metal layer as the first and second gate lines GLt and GLr.

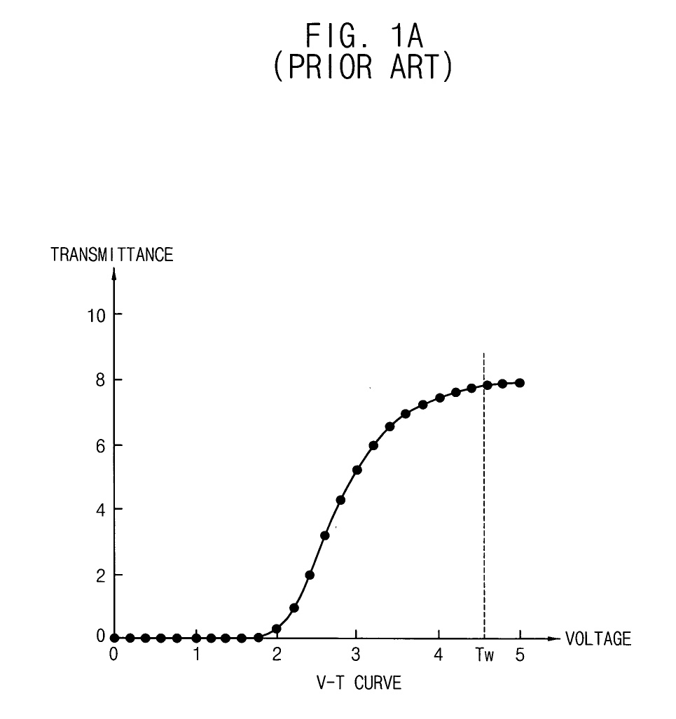

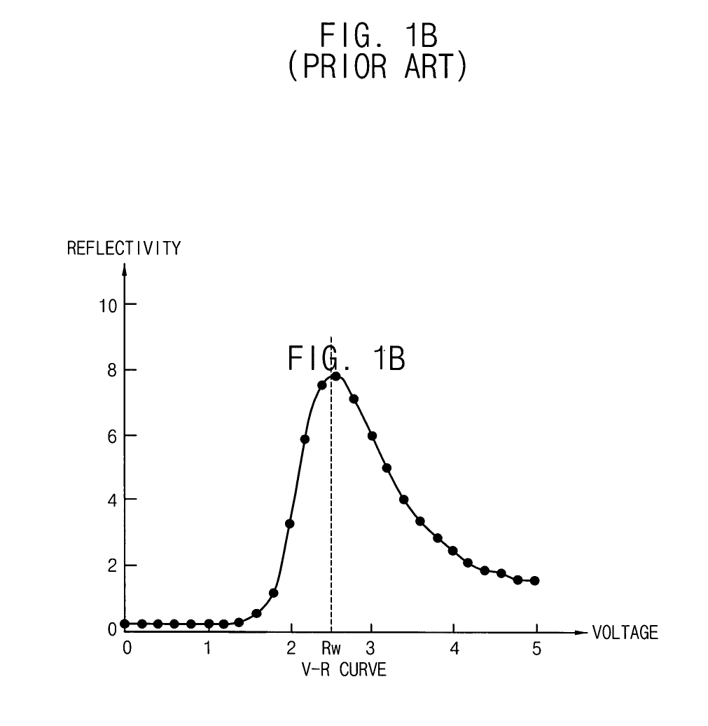

In FIGS. 1 to 3, each of the active layers 132 and 142 of the first and second switching elements TFTt and TFTr has been described as including a-Si. Alternatively, each of the active layers of the first and second switching elements TFTt and TFTr may include poly silicon.

The upper substrate 120 includes a second base substrate 121, a black matrix 122, a color filter layer 123, an overcoating layer 124, and a common electrode 125. The black matrix 122, the color filter layer 123, the overcoating layer 124 and the common electrode 125 may be formed sequentially on the second base substrate 121.

The black matrix 122 blocks a portion of the first and second lights L1 and L2. In particular, the black matrix 122 is formed on a region corresponding to the source line DL, the first and second gate lines GLt and GLr, the first and second switching elements TFTt and TFTr and an interface between the transmitting portion Pt and the reflecting portion Pr.

The color filter layer 123 corresponds to the pixel parts P, and includes a red filter pattern, a green filter pattern, and a blue filter pattern, although other colors for the color filter layer 123 are within the scope of these embodiments. The color filter layer 123 includes a light hole corresponding to a portion of the reflecting portion Pr. The light hole transmits the first light L1 so that the first light L1 passing through the transmitting portion Pt has a substantially same luminance as the second light L2 reflected from the reflecting portion Pr.

The overcoating layer 124 is on the color filter layer 123 to protect the color filter layer 123 and to planarize the second base substrate 121 having the black matrix 122 and the color filter layer 123.

The common electrode 125 corresponds to the transparent electrode TE and the reflecting electrode RE to define a first liquid crystal capacitor CLCt corresponding to the transmitting portion Pt of the pixel part P and a second liquid crystal capacitor CLCr corresponding to the reflecting portion Pr of the pixel part P. The common electrode 125 may cover an entire area, or may cover substantially an entire area of the upper substrate 120.

The liquid crystal layer 130 has a vertical alignment (“VA”) mode. When an electric field having a constant intensity is applied between the common electrode 125 and the transparent and reflecting electrodes TE and RE, the liquid crystals of the liquid crystal layer 130 are vertically aligned to display a black image.

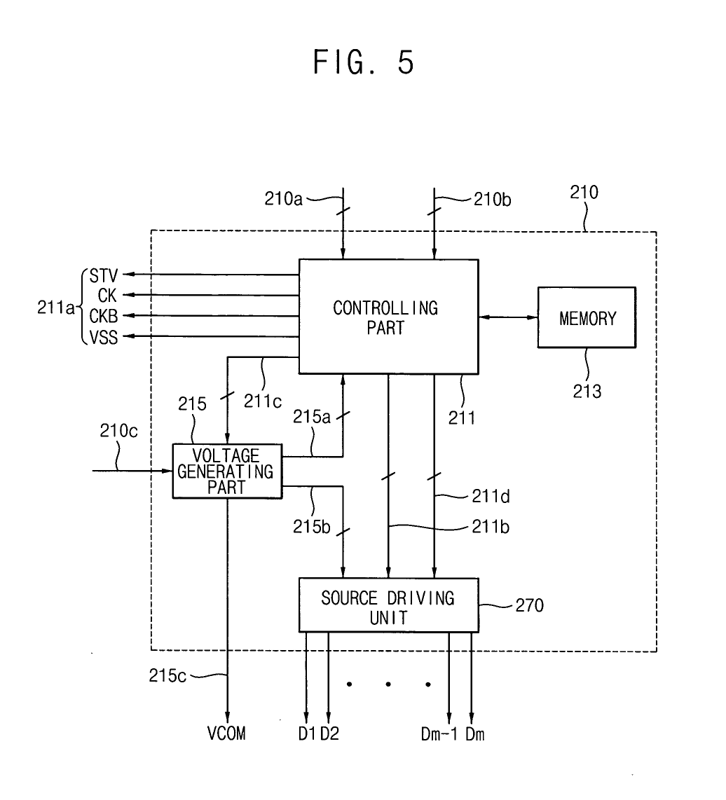

FIG. 5 is a block diagram illustrating an exemplary main driving unit shown in FIG. 2.

Referring to FIGS. 2 and 5, the main driving unit 210 includes a controlling part 211, a memory 213, a voltage generating part 215, and a source driving unit 270.

The controlling part 211 receives data signals 210a and control signals 210b from an exterior to the controlling part 211. The control signals 210b include a horizontal synchronizing signal, a vertical synchronizing signal, a main clock signal, and a data enable signal.

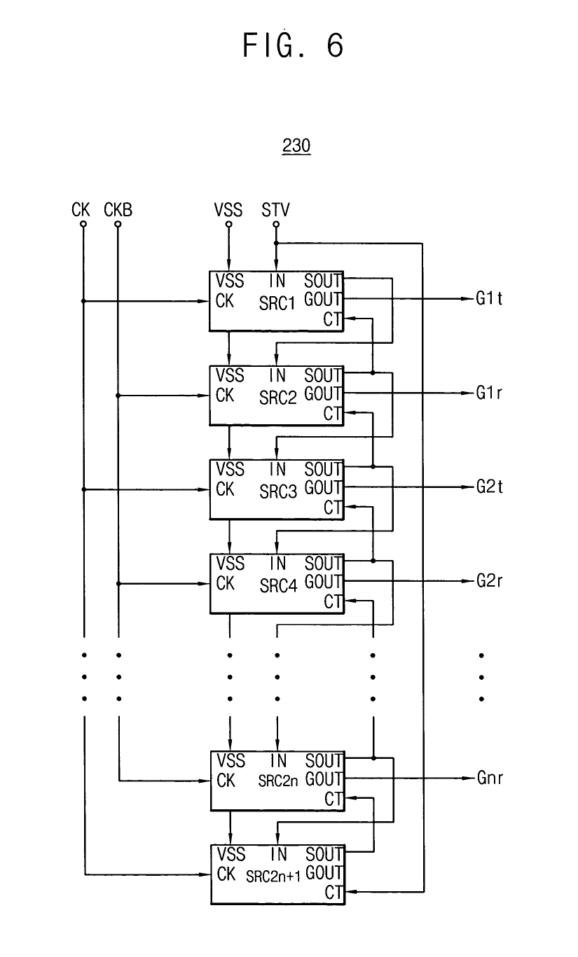

The controlling part 211 reads and writes the data signals 210a on the memory 213 based on the control signals 210b. The controlling part 211 applies gate control signals 211a to the gate circuit unit 230, as will be further described in FIG. 6. The gate control signals 211a include a vertical start signal STV, a first clock signal CK, a second clock signal CKB, and a gate voltage VSS.

The controlling part 211 applies source control signals 211b to the source driving unit 270, and applies the data signals 211d read from the memory 213 to the source driving unit 270. The source control signals 211b include a vertical start signal, a load signal, and an inversion signal.

The controlling part 211 applies control signals 211c including the main clock signal, the inversion signal, etc., to the voltage generating part 215.

The voltage generating part 215 generates driving voltages based on an externally provided electric power 210c. The driving voltages include gate voltages (VSS, VDD) 215a, reference gamma voltages (VREF) 215b, and a common voltage (VCOM) 215c. The voltage generating part 215 applies the gate voltages 215a, the reference gamma voltages 215b, and the common voltage 215c to the controlling part 211, the source driving unit 270, and the common electrode 125 of the upper substrate 120, respectively.

The voltage generating part 215 applies a first common voltage VCOMt to a first common electrode of the first liquid crystal capacitor CLCt during a first portion of a 1H period for activating the first gate line GLt, and applies a second common voltage VCOMr to a second common electrode of the second liquid crystal capacitor CLCr during a second portion of the 1H period for activating the second gate line GLr. The first common electrode may be electrically connected to the second common electrode, and the first common electrode and the second common electrode may both be part of common electrode 215.

A voltage difference between the first common voltage VCOMt and the second common voltage VCOMr is substantially the same as a voltage difference between a peak voltage Tw of the V-T curve and a peak voltage Rw of the V-R curve. For example, in FIGS. 1A and 1B, the peak voltage Tw of the V-T curve and the peak voltage Rw of the V-R curve are about 4.5V and about 2.5V, respectively, and the voltage difference between the first and second common voltages VCOMt and VCOMr is about 2V.

The source driving unit 270 converts the data signals 211d read from the memory 213 into analog data voltages D1, D2, . . . Dm to apply the analog data voltages D1, D2, . . . Dm to the source lines DL1, DL2, . . . DLm based on the reference gamma voltage VREF 215b. The source lines DL1, DL2, . . . DLm are formed on the lower substrate 110.

FIG. 6 is a block diagram illustrating an exemplary gate circuit unit shown in FIG. 2.

Referring to FIGS. 2 and 6, the gate circuit unit 230 includes a first shift register having a plurality of stages SRC1, SRC2, . . . SRC2n+1 that are electrically connected to each other, in parallel. The number of the stages SRC1, SRC2, . . . SRC2n+1 is about 2n+1. The stages SRC1, SRC2, . . . SRC2n+1 include a plurality of driving stages SRC1, SRC2, . . . SRC2n and a dummy stage SRC2n+1. The number of the driving stages SRC1, SRC2, . . . SRC2n may be equal to the number of gate lines GL1, GL2, . . . , GL2n.

Each of the stages SRC1, SRC2, . . . SRC2n+1 includes an input terminal IN, a clock terminal CK, a voltage terminal VSS, a control terminal CT, a first output terminal GOUT, and a second output terminal SOUT.

The clock terminal CK receives a first clock signal CK and a second clock signal CKB. The first clock signal CK is applied to odd numbered stages SRC1, SRC3, . . . SRC2n+1. The second clock signal CKB is applied to even numbered stages SRC2, SRC4, . . . SRC2n.

The first output terminals GOUT of the odd numbered stages SRC1, SRC3, . . . SRC2n+1 output gate signals G1t, G2t, . . . Gnt, that are synchronized with the first clock signal CK, to the odd numbered gate lines connected to the first switching elements TFTt. The first output terminals GOUT of the even numbered stages SRC2, SRC4, . . . SRC2n output gate signals G1r, G2r, . . . Gnr, that are synchronized with the second clock signal CKB, to the even numbered gate lines connected to the second switching elements TFTr.

The first output terminal GOUT of the first stage SRC1, and subsequent odd-numbered stages, is electrically connected to the first gate line GLt of the transmitting portion Pt to control an operation of the first switching element TFTt. The first output terminal GOUT of the second stage SRC2, and subsequent even-numbered stages, is electrically connected to the second gate line GLr of the reflecting portion Pr to control an operation of the second switching element TFTr.

In FIGS. 2 to 6, the first stage SRC1 applies the first gate signal G1t to the first gate line GLt during an initial H/2 period of the 1H period. The second stage SRC2 applies the second gate signal G1r to the second gate line GLr during a latter H/2 period of the 1H period. Thus, the stages SRC1, SRC2, . . . SRC2n apply the gate signals G1t, G1r, G2t, G2r, . . . Gnt and Gnr to the gate lines, respectively.

The first output terminal GOUT of the dummy stage SRC2n+1 is not electrically connected to a gate line to be floated.

Each of the second output terminals SOUT of the odd numbered stages SRC1, SRC3, . . . SRC2n+1 outputs the first clock signal CK as a stage driving signal. In addition, each of the second output terminals SOUT of the even numbered stages SRC2, SRC4, . . . SRC2n outputs the second clock signal CKB as a stage driving signal.

The input terminal IN of each of the odd numbered stages SRC1, SRC3, . . . SRC2n+1 receives the stage driving signal outputted from the second output terminal SOUT of a previous stage. The control terminal CT of each of the odd numbered stages SRC1, SRC3, . . . SRC2n+1 receives the stage driving signal outputted from a next stage.

The first stage SRC1 does not have a previous stage so that the input terminal IN of the first stage SRC1 receives the vertical start signal STV. In addition, the dummy stage SRC2n+1 that is the last stage does not have a next stage so that the control terminal CT of the dummy stage SRC2n+1 receives the vertical start signal STV.

Each of the stages SRC1, SRC2, . . . SRC2n+1 may further include a voltage terminal receiving a gate off voltage VSS.

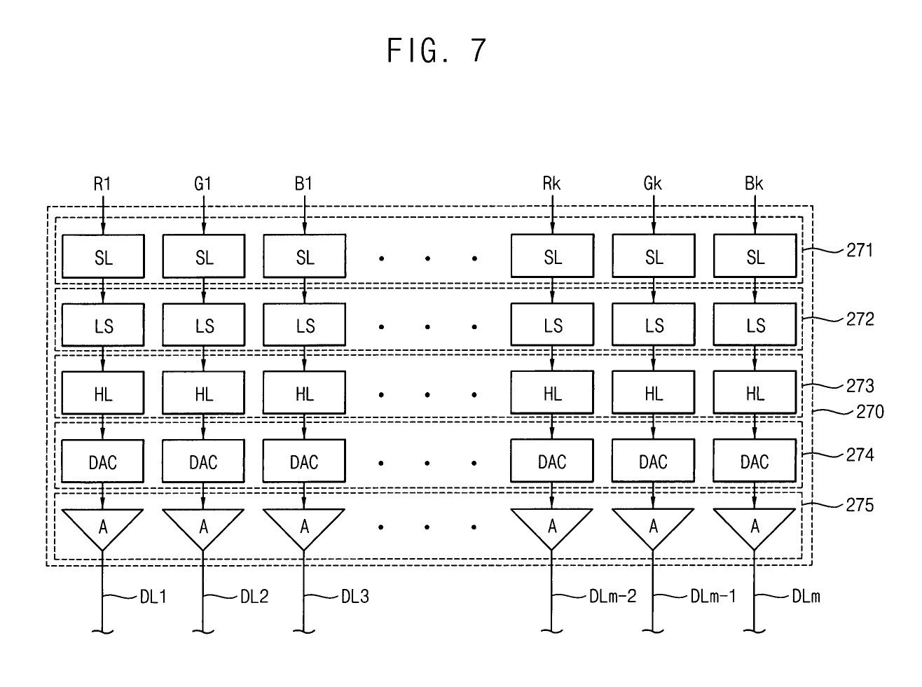

FIG. 7 is a block diagram illustrating an exemplary source driving unit shown in FIG. 5.

Referring to FIGS. 5 and 7, the source driving unit 270 includes a sample latching part 271, a level shifting part 272, a hold latching part 273, a digital-analog converting part 274, and an output buffering part 275.

The sample latching part 271 includes a plurality of sampling latches SL to latch a plurality of data signals R1, G1, B1, R2, G2, B2, . . . Rk, Gk, and Bk corresponding to the 1H period, in sequence. The latched data signals R1, G1, B1, R2, G2, B2, . . . Rk, Gk, and Bk are from the controlling part 211.

The level shifting part 272 includes a plurality of level shifters LS. The level shifting part 272 shifts levels of the data signals R1, G1, B1, R2, G2, B2, . . . Rk, Gk, and Bk outputted from the sample latching part 271 to predetermined levels, respectively.

The hold latching part 273 includes a plurality of hold latches HL. The hold latching part 273 latches the data signals outputted from the level shifting part 272, in sequence, to lead the latched data signals based on the source control signals 211b outputted from the controlling part 211.

The digital analog converting part 274 includes a plurality of digital analog converters DAC to convert the loaded data signals that are loaded from the hold latching part 272 into analog data voltages based on the reference gamma voltages VREF 215b to apply the analog data voltages to the output buffering part 275.

The output buffering part 275 includes a plurality of amplifiers A to amplify the analog data voltages outputted from the digital analog converting part 274 at predetermined levels, respectively, to the source lines DL1, DL2, DL3, . . . DLm-2, DLm-1 and DLm.

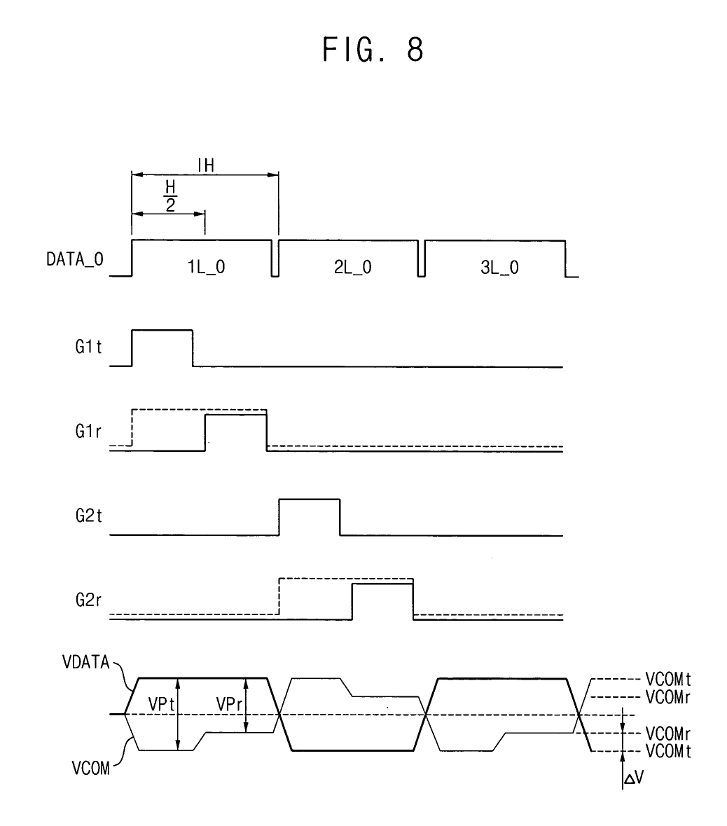

FIG. 8 is a timing diagram illustrating an exemplary method of driving an exemplary LCD device using the exemplary source driving unit shown in FIG. 7.

Referring to FIGS. 1A to 8, the source driving unit 270 converts the data signals 211d from the controlling part 211 into the analog data voltages DATA_{—}0 to the source lines DL1, DL2, . . . DLm during the 1H period. For example, the source driving unit 270 inverses the data signals 211d through a line inversion method during the 1H period, and applies the data signals 211d to the source lines DL1, DL2, . . . DLm.

In particular, the source driving unit 270 generates a data voltage 1L_{—}0 of a first horizontal line. The gate circuit unit 230 generates a first gate signal G1t of the first horizontal line during the initial H/2 period of the 1H period. In addition, the voltage generating part 215 applies the first common voltage VCOMt to the common electrode 125 of the upper substrate during the initial H/2 period of the 1H period.

Thus, the first switching element TFTt of the transmitting portion Pt is turned on based on the first gate signal G1t to apply a voltage corresponding to the data voltage from the source line DL to the transparent electrode TE of the first liquid crystal capacitor CLCt. The transparent electrode TE is a first electrode of the first liquid crystal capacitor CLCt. The first common voltage VCOMt is applied to the common electrode 125. The common electrode 125 is a second electrode of the first liquid crystal capacitor CLCt.

A first pixel voltage VPt corresponding to a voltage difference between the transparent electrode TE and the common electrode 125 is stored in the first liquid crystal capacitor CLCt.

The source driving unit 270 then generates a data voltage 1L_{—}0 of the first horizontal line. The gate circuit unit 230 generates a second gate signal G1r of the first horizontal line during the latter H/2 period of the 1H period. In addition, the voltage generating part 215 applies the second common voltage VCOMr to the common electrode 125 of the upper substrate 120 during the latter H/2 period of the 1H period.

That is, the first switching element TFTt of the transmitting portion Pt is turned off, and the second switching element TFTr of the reflecting portion Pr is turned on during the latter H/2 period.

Thus, the second switching element TFTr of the reflecting portion Pr is turned on based on the second gate signal G1r to apply a voltage corresponding to the data voltage from the source line DL to the reflecting electrode RE of the second liquid crystal capacitor CLCr. The reflecting electrode RE is a first electrode of the second liquid crystal capacitor CLCr. The second common voltage VCOMr is applied to the common electrode 125. The common electrode 125 is a second electrode of the second liquid crystal capacitor CLCr.

A second pixel voltage VPr corresponding to a voltage difference between the reflecting electrode RE and the common electrode 125 is stored in the second liquid crystal capacitor CLCr.

In FIG. 8, the first pixel voltage VPt stored in the first liquid crystal capacitor CLCt has different levels from the second pixel voltage VPr stored in the second liquid crystal capacitor CLCr. Referring again to FIGS. 1A and 1B, a voltage difference between the first common voltage VCOMt and the second common voltage VCOMr is substantially the same as the voltage difference of the peak voltage Tw of the V-T curve and the peak voltage Rw of the V-R curve.

For example, when the peak voltage Tw of the V-T curve and the peak voltage Rw of the V-R curve are about 4.5V and about 2.5V, the voltage difference ΔV between the first and second common voltages VCOMt and VCOMr is about 2V. In particular, when the liquid crystal layer 130 has the VA mode, an absolute value of the first common voltage VCOMt applied to the first liquid crystal capacitor CLCt of the transmitting portion Pt is greater than an absolute value of the second common voltage VCOMr applied to the second liquid crystal capacitor CLCr of the reflecting portion Pr by the voltage difference AV.

In FIGS. 1A to 8, the first switching element TFTt electrically connected to the first gate line GL1t is turned on to drive the transmitting portion Pt during the initial H/2 period of a 1H period. In addition, the first switching element TFTt is turned off, and the second switching element TFTr electrically connected to the second gate line GL1r is turned on to drive the reflecting portion Pr during the latter H/2 period of the 1H period.

Alternatively, referring to dotted lines of FIG. 8, the first and second switching elements TFTt and TFTr may be simultaneously turned on to drive both the transmitting and reflecting portions Pt and Pr during the initial H/2 period, and the first switching element TFTt may be turned off during the latter H/2 period, while the second switching element TFTr remains on, to drive the reflecting portion Pr. The dotted lines of FIG. 8 correspond to second and fourth gate signals G1r and G2r according to such an embodiment.

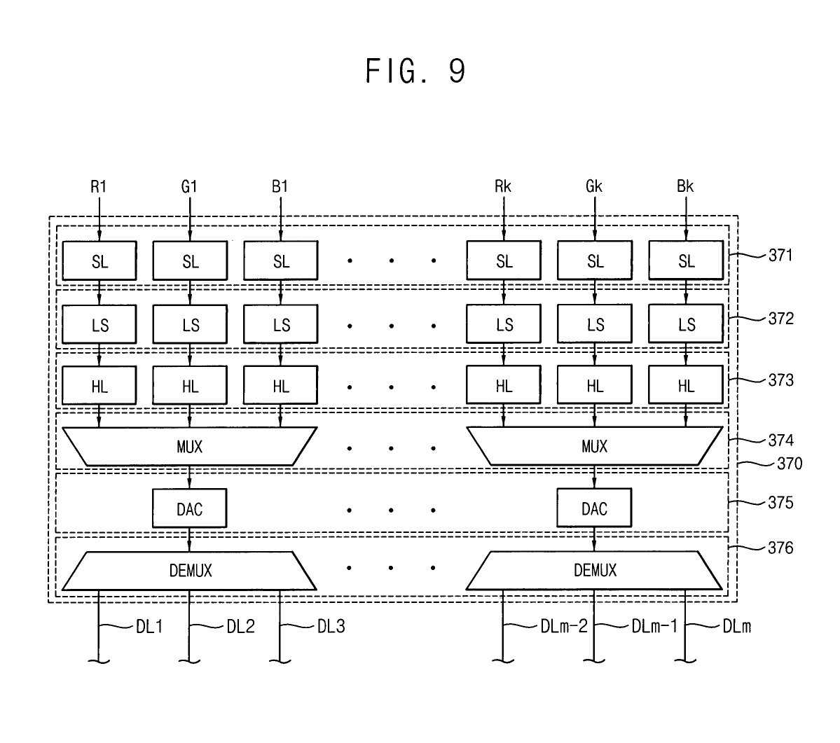

FIG. 9 is a block diagram illustrating an exemplary source driving unit in accordance with another exemplary embodiment of the present invention.

Referring to FIGS. 5 and 9, the source driving unit 370 replaces the source driving unit 270 of FIG. 5 and includes a sample latching part 371, a level shifting part 372, a hold latching part 373, a multiplexer (“MUX”) part 374, a digital analog converting part 375 and a demultiplexer (“DEMUX”) part 376. The sample latching part 371, the level shifting part 372, and the hold latching part 373 of FIG. 9 may be substantially the same as the sample latching part 271, the level shifting part 272, and the hold latching part 273 in FIG. 7. Thus, any further explanation concerning the above elements will be omitted.

The MUX part 374 combines multiple inputs from the hold latching part 373. Then, the MUX part 374 divides the data signals outputted from the hold latching part 373 into a plurality of groups. The MUX part 374 controls an output of the data signals of each of the groups.

Particularly, the MUX part 374 divides the data signals R1, G1, B1, . . . Rk, Gk and Bk into a red data group R1, R2, . . . Rk, a green data group G1, G2, . . . Gk, and a blue data group B1, B2, . . . Bk. The MUX part 374 controls the output of each of the red, green and blue data signals R1, G1, B1, . . . Rk, Gk, and Bk.

The MUX part 374 applies the red data group R1, R2, . . . Rk to a DAC of the digital analog converting part 375, then applies the green data group G1, G2, . . . Gk to a DAC of the digital analog converting part 375, and then applies the blue data group B1, B2, . . . Bk to a DAC of the digital analog converting part 375. Thus, the number of the DACs of the digital analog converting part 375 shown in FIG. 9 is about one third of the number of the DACs of the digital analog converting part of FIG. 7.

The DAC part 375 converts the red data signals R1, R2, . . . Rk into red analog data voltages to apply the red analog data voltages to the DEMUX part 376. The DEMUX part 376 applies the red analog data voltages to the source lines DL1, DL4, . . . DLm-2 corresponding to red pixel parts through first output terminals that are electrically connected to the source lines DL1, DL4, . . . DLm-2 corresponding to the red pixel parts.

The DAC part 375 then converts the green data signals G1, G2, . . . Gk into green analog data voltages to apply the green analog data voltages to the DEMUX part 376. The DEMUX part 376 applies the green analog data voltages to the source lines DL2, DL5, . . . DLm-1 corresponding to green pixel parts through second output terminals that are electrically connected to the source lines DL2, DL5, . . . DLm-1 corresponding to the green pixel parts

The DAC part 375 then converts the blue data signals B1, B2, . . . Bk into blue analog data voltages to apply the blue analog data voltages to the DEMUX part 376. The DEMUX part 376 applies the blue analog data voltages to the source lines DL3, DL6, . . . DLm corresponding to blue pixel parts through third output terminals that are electrically connected to the source lines DL3, DL6, . . . DLm corresponding to the blue pixel parts

Therefore, the data voltages applied to the source lines DL1, DL2, . . . DLm are divided into the red, green and blue analog data voltages, and the source driving unit 370 controls an application of the red analog data voltages to the source lines DL1, DL4, . . . DLm-2 corresponding to the red pixel parts. The source driving unit 370 then controls an application of the green analog data voltages to the source lines DL2, DL5, . . . DLm-1 corresponding to the green pixel parts. The source driving unit 370 then controls an application of the blue analog data voltages to the source lines DL3, DL6, . . . DLm corresponding to the blue pixel parts.

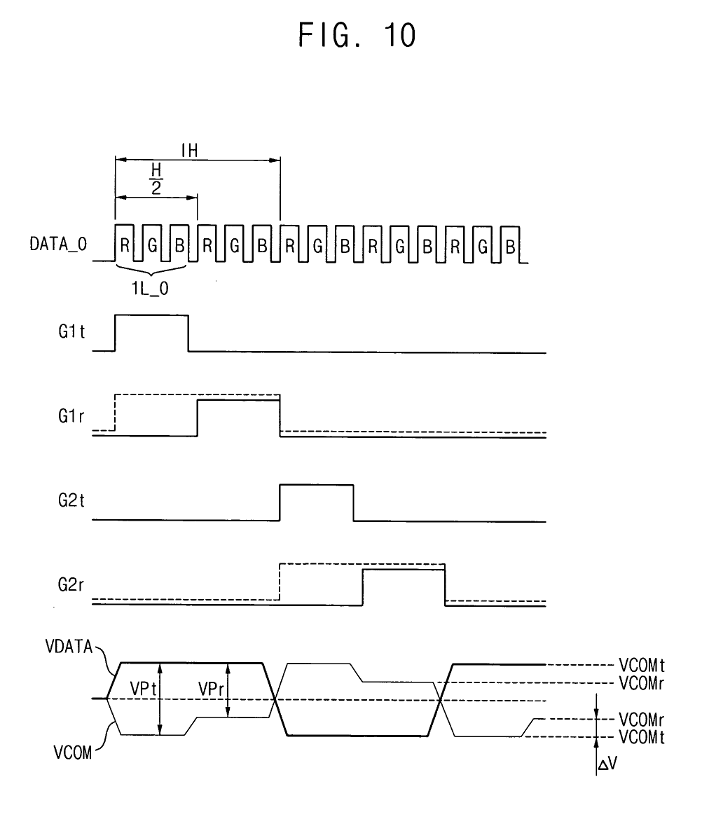

FIG. 10 is a timing diagram illustrating an exemplary method of driving an exemplary LCD device using the exemplary source driving unit shown in FIG. 9.

Referring to FIGS. 1A, 5, 6, 9 and 10, the source driving unit 370 converts the data signals of a horizontal line into the analog data voltages DATA_{—}0 to the source lines DL1, DL2, . . . DLm during the 1H period. The data signals 211d of the horizontal line are from the controlling part 211. For example, the source driving unit 370 inverses the data signals 211d through a line inversion method during the 1H period, and applies the data signals 211d to the source lines DL1, DL2, . . . DLm.

Particularly, the source driving unit 370 generates a data voltage of a first horizontal line. The source driving unit 370 generates a first gate signal G1t of the first horizontal line. In addition, a voltage generating part 215 applies a first common voltage VCOMt to a common electrode 125 of an upper substrate 120. The source driving unit 370 divides the data voltages 1L_{—}0 of horizontal lines into a group of red data voltages, a group of green data voltages, and a group of blue data voltages through a 3×1 MUX method.

A first switching element TFTt of the transmitting portion Pt is turned on based on the first gate signal G1t to apply a voltage corresponding to the data voltage that is from the source line DL to a transparent electrode TE of a first liquid crystal capacitor CLCt. The transparent electrode TE is a first electrode of the first liquid crystal capacitor CLCt. A first common voltage VCOMt is applied to the common electrode 125. The common electrode 125 is a second electrode of the first liquid crystal capacitor CLCt.

A first pixel voltage VPt corresponding to a voltage difference between the transparent electrode TE and the common electrode 125 is stored in the first liquid crystal capacitor CLCt.

The source driving unit 370 also outputs the data voltage 1L_{—}0 corresponding to the first horizontal line during a latter H/2 period of the 1H period. The gate circuit unit 230 generates a second gate signal G1r corresponding to the first horizontal line during the latter H/2 period of the 1H period. In addition, the voltage generating part 215 applies the second common voltage VCOMr to the common electrode 125 of the upper substrate 120 during the latter H/2 period of the 1H period.

That is, the first switching element TFTt of the transmitting portion Pt is turned off, and the second switching element TFTr of the reflecting portion Pr is turned on during the latter H/2 period.

Thus, the second switching element TFTr of the reflecting portion Pr is turned on based on the second gate signal G1r to apply a voltage corresponding to the data voltage from the source line DL to a reflecting electrode RE of a second liquid crystal capacitor CLCr. The reflecting electrode RE is a first electrode of the second liquid crystal capacitor CLCr. The second common voltage VCOMr is applied to the common electrode 125. The common electrode 125 is a second electrode of the second liquid crystal capacitor CLCr.

A second pixel voltage VPr corresponding to a voltage difference between the reflecting electrode RE and the common electrode 125 is stored in the second liquid crystal capacitor CLCr.

In FIG. 10, the first pixel voltage VPt stored in the first liquid crystal capacitor CLCt has different levels from the second pixel voltage VPr stored in the second liquid crystal capacitor CLCr. Referring again to FIGS. 1A and 1B, the voltage difference between the first common voltage VCOMt and the second common voltage VCOMr is substantially same as the voltage difference between the peak voltage Tw of the V-T curve and the peak voltage Rw of the V-R curve.

For example, when the peak voltage Tw of the V-T curve and the peak voltage Rw of the V-R curve are about 4.5V and about 2.5V, respectively, the voltage difference ΔV between the first and second common voltages VCOMt and VCOMr is about 2V. In particular, when the liquid crystal layer 130 has the VA mode, an absolute value of the first common voltage VCOMt applied to the first liquid crystal capacitor CLCt of the transmitting portion Pt is greater than an absolute value of the second common voltage VCOMr applied to the second liquid crystal capacitor CLCr of the reflecting portion Pr by the voltage difference ΔV.

In FIGS. 1A, 5, 6, 9 and 10, the first switching element TFTt electrically connected to the first gate line GL1t is turned on to drive the transmitting portion Pt during the initial H/2 period. In addition, the first switching element TFTt is turned off, and the second switching element TFTr electrically connected to the second gate line GL1r is turned on to drive the reflecting portion Pr during the latter H/2 period.

Alternatively, referring to dotted lines of FIG. 10, the first and second switching elements TFTt and TFTr may be simultaneously turned on to drive both the transmitting and reflecting portions Pt and Pr during the initial H/2 period, and the first switching element TFTt may be turned off, while the second switching element TFTr may remain on, during the latter H/2 period to drive the reflecting portion Pr. The dotted lines of FIG. 10 correspond to second and fourth gate signals G1r and G2r according to such an embodiment.

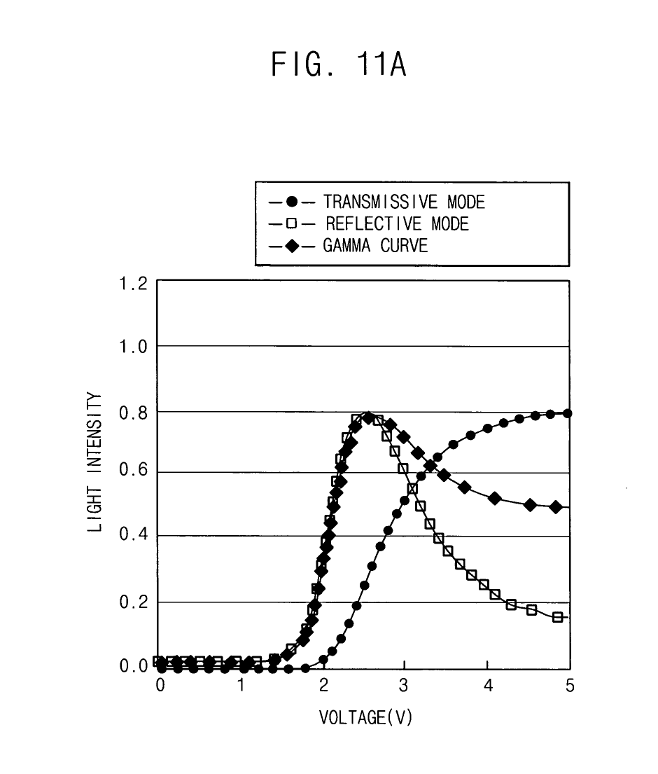

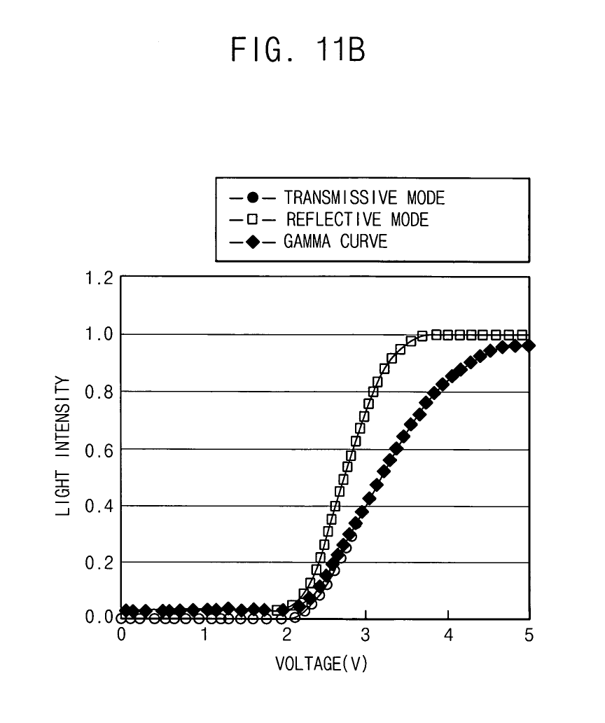

FIGS. 11A is a graph illustrating a V-T curve and a V-R curve of an LCD device of a VA mode, and FIG. 11B is a graph illustrating a V-T curve and a V-R curve of an exemplary LCD device of a VA mode in accordance with another exemplary embodiment of the present invention.

FIG. 11A is a graph illustrating a V-T curve and a V-R curve of an LCD device having a common electrode receiving a voltage of a substantially same level.

Referring to FIG. 11A, in the V-T curve of the VA mode, a light transmittance is gradually increased at a voltage between about 1.5V to about 4.5V, and the light transmittance has a maximum transmittance at a voltage of about 4.5V. However, in the V-R curve of the VA mode, a light reflectivity is gradually increased at a voltage between about 1.5V to about 2.5V, and is gradually decreased at a voltage greater than about 2.5V.

Therefore, in a gamma curve shown in FIG. 11A that is an average of the V-R curve and the V-T curve, a light intensity is gradually increased at a voltage lower than about 2.5V, and is gradually decreased at a voltage greater than about 2.5V. Thus, the LCD device may not display an image of a white gray-scale.

FIG. 11B is a graph illustrating a V-T curve and a V-R curve of an exemplary LCD device having common electrodes receiving voltages of different levels.

Referring to FIG. 11B, in the V-T curve of the VA mode, a light transmittance is gradually increased at a voltage greater than about 1.5V, and the light transmittance has a maximum transmittance at a voltage of about 4.5V. However, in the V-R curve of the VA mode, a light reflectivity is gradually increased at a voltage greater than about 2V, and has a maximum reflectivity at a voltage greater than about 3.5V.

Therefore, in a gamma curve that is an average of the V-R curve and the V-T curve, a light intensity is gradually increased at a voltage greater than about 2V, and has a maximum intensity at a voltage greater than about 4V. Thus, the LCD device may display an image of a white gray-scale.

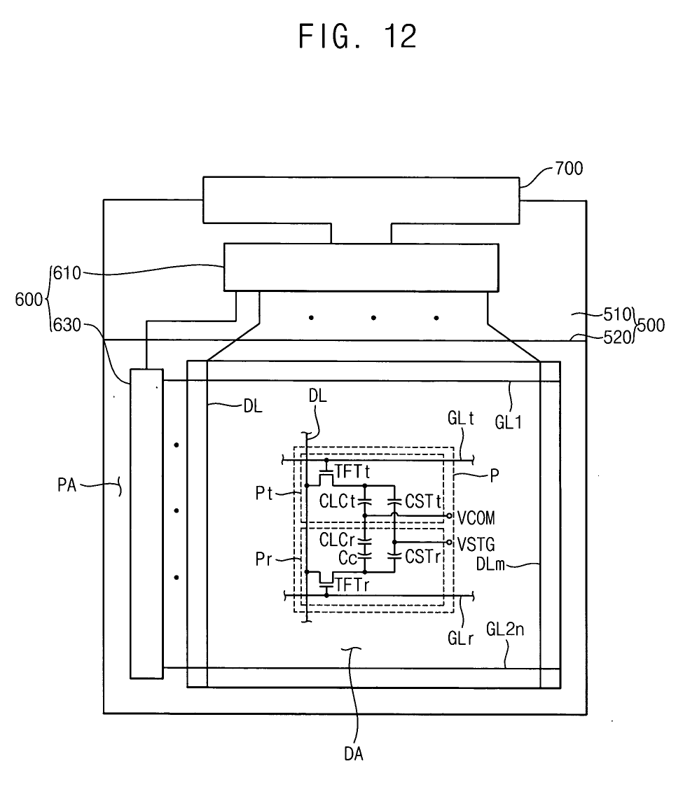

FIG. 12 is a plan view illustrating an exemplary LCD device in accordance with another exemplary embodiment of the present invention.

Referring to FIG. 12, the LCD device includes an LCD panel 500, a driving module 600, and an FPC 700.

The LCD panel 500 includes a lower substrate 510, an upper substrate 520 and a liquid crystal layer (not shown). The liquid crystal layer (not shown) is interposed between the lower substrate 510 and the upper substrate 520. The liquid crystal layer (not shown) has a VA mode. When an electric field having a constant intensity is applied to the liquid crystal layer, liquid crystals of the liquid crystal layer are vertically aligned.

The LCD panel 500 includes a display region DA and a peripheral region PA surrounding the display region DA. A plurality of source lines DL1, DL2, . . . DLm, also known as data lines, extending in a first direction from a main driving unit 610, and a plurality of gate lines GL1, GL2, . . . GL2n, also known as scanning lines, extending in a second direction substantially perpendicular to the first direction from a gate circuit unit 630, are formed in the display region DA. The gate lines GL1, GL2, . . . GL2n cross the source lines DL1, DL2, . . . DLm. The number of the source lines DL1, DL2, . . . DLm and the number of the gate lines GL1, GL2, . . . GL2n are ‘m’ and ‘2n’, respectively, where ‘n’ and ‘m’ are natural numbers. A plurality of pixel parts P is defined in the display region DA by the source and gate lines DL1, DL2, . . . DLm, and GL1, GL2, . . . GL2n. The number of the pixel parts P is about m×n.

Each of the pixel parts P includes a transmitting portion Pt and a reflecting portion Pr. The transmitting portion Pt and the reflecting portion Pr are defined by a first gate line GLt, a second gate line GLr, and a source line DL. A first light passes through the transmitting portion Pt, such as through lower and upper substrates 510, 520. A second light is reflected from the reflecting portion Pr, such as by first passing through the upper substrate 520, and then being reflected back through the upper substrate 520. The liquid crystal layer (not shown) corresponding to the transmitting portion Pt has a substantially same cell-gap as the liquid crystal layer (not shown) corresponding to the reflecting portion Pr.

The transmitting portion Pt includes a first switching element TFTt, a first liquid crystal capacitor CLCt, and a first storage capacitor CSTt. The first switching element TFTt may include a thin film transistor (“TFT”). The first switching element TFTt is electrically connected to the source line DL and the first gate line GLt. The first switching element TFTt includes a source electrode connected to the source line DL and a gate electrode connected to the first gate line GLt. The first liquid crystal capacitor CLCt and the first storage capacitor CSTt are electrically connected to the first switching element TFTt. The first switching element TFTt includes a drain electrode for electrically connecting to the first liquid crystal capacitor CLCt.

The reflecting portion Pr includes a second switching element TFTr, a cell capacitor Cc, a second liquid crystal capacitor CLCr, and a second storage capacitor CSTr. The second switching element TFTr may also be a thin film transistor (“TFT”). The second switching element TFTr is electrically connected to the source line DL and the second gate line GLr. The second switching element TFTr includes a source electrode connected to the source line DL and a gate electrode connected to the second gate line GLr. The cell capacitor Cc is electrically connected to the second switching element TFTr. The second liquid crystal capacitor CLCr is electrically connected to the cell capacitor Cc, in serial. The second storage capacitor CSTr is electrically connected to the second switching element TFTr. The second switching element TFTr includes a drain electrode for electrically connecting to the second liquid crystal capacitor CLCr.

Common electrodes of the first and second liquid crystal capacitors CLCt and CLCr are integrally formed with each other to form one common electrode of the first and second liquid crystal capacitors CLCt and CLCr. A first common electrode of the first storage capacitor CSTt is electrically connected to a second common electrode of the second storage capacitor CSTr.

In an operation of each of the pixel parts P, the first switching element TFTt is turned on based on an activation of the first gate line GLt so that a data voltage from the source line DL is applied to a first electrode of the first liquid crystal capacitor CLCt. For example, the first electrode of the first liquid crystal capacitor CLCt may be a transparent electrode. In addition, a common voltage VCOM is applied to the common electrode of the first liquid crystal capacitor CLCt. The common electrode of the first liquid crystal capacitor CLCt is a second electrode of the first liquid crystal capacitor CLCt. Thus, a first pixel voltage VPt corresponding to a voltage difference between the data voltage and the common voltage VCOM is stored in the first liquid crystal capacitor CLCt of the transmitting portion Pt.

The first gate line GLt is then deactivated to turn off the first switching element TFTt, and the second gate line GLr is activated to turn on the second switching element TFTr. When the second switching element TFTr is turned on, the data voltage from the source line DL is applied to a first electrode of the second liquid capacitor CLCr. For example, the first electrode of the second liquid crystal capacitor CLCr is a reflecting electrode. The common voltage VCOM is applied to the common electrode of the second liquid crystal capacitor CLCr. The common electrode of the second liquid crystal capacitor CLCr is a second electrode of the second liquid crystal capacitor CLCr. In FIG. 12, the common electrode of the first liquid crystal capacitor CLCt is integrally formed with the common electrode of the second liquid crystal capacitor CLCr, where the common electrode may be formed on the upper substrate 520.

A portion of the data voltage is stored in the cell capacitor Cc, and the cell capacitor Cc is electrically connected to the second liquid crystal capacitor CLCr, in serial. Thus, a remaining portion of the data voltage is stored in the second liquid crystal capacitor CLCr so that a second pixel voltage VPr that is smaller than the first pixel voltage VPt is stored in the second liquid crystal capacitor CLCr of the reflecting portion Pr.

That is, a capacitance of the cell capacitor Cc is adjusted so that a difference between a voltage of a white gray scale and a voltage of a black gray scale of a V-T curve is substantially the same as a difference between a voltage of a white gray scale and a voltage of a black gray scale of a V-R curve.

In addition, the common voltage VCOM applied to the common electrode of the first and second liquid crystal capacitors CLCt and CLCr is adjusted to compensate an offset value of the adjusted V-T and V-R curves.

A first common voltage VSTGt and a second common voltage VSTGr are applied to the first and second common electrodes of the first and second storage capacitors CSTt and CSTr in a substantially same method as the first and second common voltages VCOMt and VCOMr, respectively. The common voltage VCOM applied to the first and second liquid crystal capacitors CLCt and CLCr is substantially the same as the common voltage VSTG applied to the first and second storage capacitors CSTt and CSTr.

That is, the first common voltage VSTGt is applied to the first storage capacitor CSTt during a portion of a time period when the first switching element TFTt of the transmitting portion Pt is being driven. The first common voltage VSTGt applied to the first storage capacitor CSTt is substantially the same as the first common voltage VCOMt applied to the first liquid crystal capacitor CLCt. The second common voltage VSTGr is applied to the second storage capacitor CSTr during a portion of a time period when the second switching element TFTr of the reflecting portion Pr is being driven. The second common voltage VSTGr applied to the second storage capacitor CSTr is substantially the same as the second common voltage VCOMr applied to the second liquid crystal capacitor CLCr.

The driving module 600 includes a main driving unit 610 and a gate circuit unit 630.

The main driving unit 610 may include a chip in the peripheral region PA to apply driving signals to the pixel parts P based on control signals and data signals from the FPC 700. The main driving unit 610 may be located on the lower substrate 510.

The gate circuit unit 630 may be integrated onto the peripheral region PA. Alternatively, the gate circuit unit 630 may include a chip in the peripheral region PA. The gate circuit unit 630 applies gate signals G1t, G1r, G2t, G2r, . . . Gnt and Gnr to the gate lines GL1, GL2, . . . , GL2n based on the driving signals from the main driving unit 610. For example, first and second gate signals G1t and G1r of the gate signals G1t, G1r, G2t, G2r, . . . Gnt and Gnr may be applied to the pixel parts P during one horizontal period 1H. For example, the 1H period may be one frame. Alternatively, the 1H period may be an effective display period that is a portion of the frame.

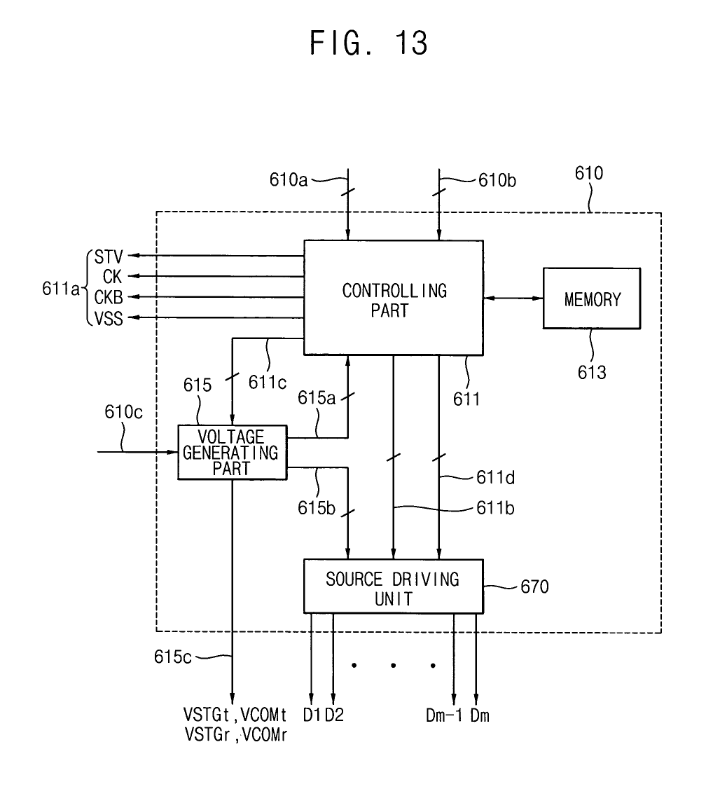

FIG. 13 is a block diagram illustrating an exemplary main driving unit shown in FIG. 12.

Referring to FIGS. 12 and 13, the main driving unit 610 includes a controlling part 611, a memory 613, a voltage generating part 615, and a source driving unit 670.

The controlling part 611 receives data signals 610a and control signals 610b from an exterior to the controlling part 611. The control signals 610b include a horizontal synchronizing signal, a vertical synchronizing signal, a main clock signal, and a data enable signal.

The controlling part 611 reads and writes the data signals 610a on the memory 613 based on the control signals 610b. The controlling part 611 applies gate control signals 611a to the gate circuit unit 630. The gate control signals 611a include a vertical start signal STV, a first clock signal CK, a second clock signal CKB, and a gate voltage VSS.

The controlling part 611 applies source control signals 611b to the source driving unit 670, and applies the data signals 611d read from the memory 613 to the source driving unit 670. The source control signals 611b include a vertical start signal, a load signal, and an inversion signal.

The controlling part 611 applies control signals 611c including the main clock signal, the inversion signal, etc., to the voltage generating part 615.

The voltage generating part 615 generates driving voltages based on an externally provided electric power 610c. The driving voltages include gate voltages (VSS, VDD) 615a, reference gamma voltages (VREF) 615b, common voltages VCOMt and VCOMr applied to the common electrode of the upper substrate 620, and common voltages (VSTGt, VSTGr) 615c applied to the common electrode (such as the storage common electrodes) of the storage capacitors of the lower substrate 610. The voltage generating part 615 applies the gate voltages (VSS, VDD) 615a and the reference gamma voltages (VREF) 615b to the controlling part 611 and the source driving unit 670, respectively.

The voltage generating part 615 also applies the first common voltage VCOMt to the first common electrode of the first liquid crystal capacitor CLCt during a first portion of the 1H period for activating the first gate line GLt, and applies the second common voltage VCOMr to the second common electrode of the second liquid crystal capacitor CLCr during a second portion of the 1H period for activating the second gate line GLr.

The voltage generating part 615 applies the first and second common voltages VSTGt and VSTGr to the first and second common electrodes (such as first and second storage common electrodes) of the first and second storage capacitors CSTt and CSTr through a substantially same method as the application of the first and second common voltages VCOMt and VCOMr, respectively.

The second common voltage VCOMr is a predetermined value determined by an experiment to compensate an offset value between the data voltage of the transmission mode and the data voltage of the reflection mode. For example, a dielectric constant of the liquid crystal layer corresponding to the data voltage of the transmission mode may be compared with a dielectric constant of the liquid crystal layer corresponding to the data voltage of the reflection mode to determine the second common voltage VCOMr.

The source driving unit 670 converts the data signals 611d read from the memory 613 into analog data voltages D1, D2, . . . Dm to apply the analog data voltages D1, D2, . . . Dm to the source lines DL1, DL2, . . . DLm based on the reference gamma voltage VREF 615b.

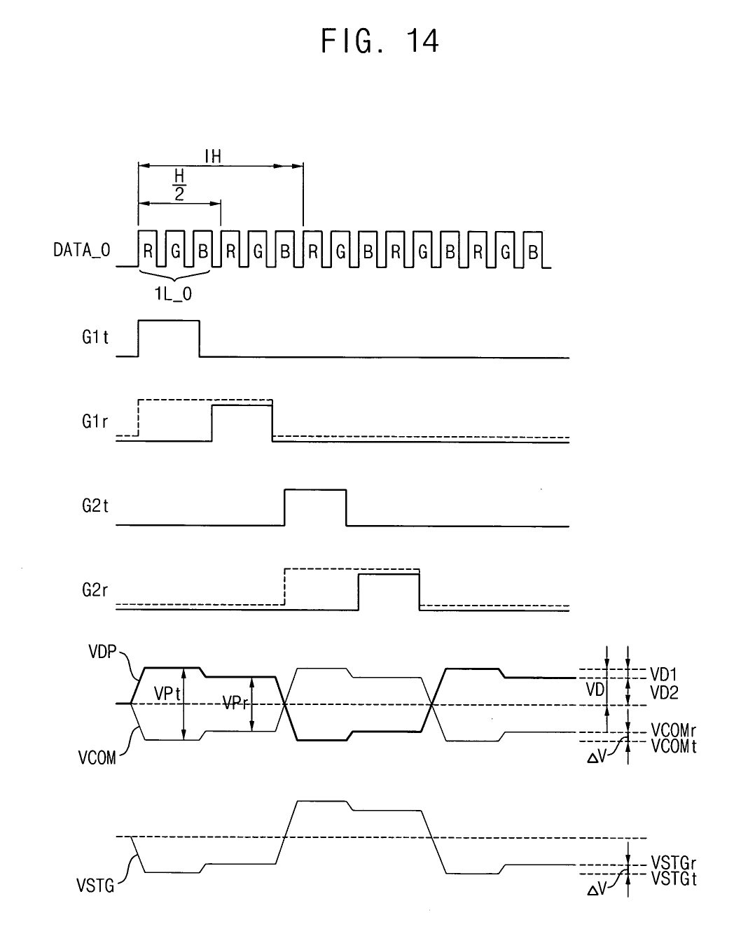

FIG. 14 is a timing diagram illustrating an exemplary method of driving the exemplary LCD device shown in FIG. 12.

Referring to FIGS. 12 to 14, the source driving unit 670 converts the data signals 611d from the controlling part 611 into the analog data voltages DATA_{—}0 to the source lines DL1, DL2, . . . DLm during the 1H period. The data signals 611d from the controlling part 611 correspond to horizontal lines of the LCD device. For example, the source driving unit 670 inverses the data signals 611d through a line inversion method during the 1H period, and applies the data signals 611d to the source lines DL1, DL2, . . . DLm.

In particular, the source driving unit 670 generates data voltages 1L_{—}0 of a first horizontal line. The source driving unit 670 generates a first gate signal G1t of the first horizontal line during an initial H/2 period of the 1H period. In addition, the voltage generating part 615 applies a first common voltage VCOMt to a common electrode of an upper substrate 620 during the initial H/2 period of the 1H period. The voltage generating part 615 also applies a third common voltage VSTGt having a substantially same level as the first common voltage VCOMt to a storage common electrode of the lower substrate. In the exemplary embodiment shown, the source driving unit 670 divides the data voltages 1L_{—}0 into a group of red data voltages, a group of green data voltages, and a group of blue data voltages through a 3×1 MUX method.

A first switching element TFTt of the transmitting portion Pt is turned on based on the first gate signal G1t to apply the data voltage from the source line DL to a transparent electrode TE of a first liquid crystal capacitor CLCt. The transparent electrode TE is a first electrode of the first liquid crystal capacitor CLCt. A first common voltage VCOMt is applied to a common electrode of the upper substrate 620. The common electrode is a second electrode of the first liquid crystal capacitor CLCt.

A first pixel voltage VPt corresponding to a voltage difference between the data voltage VD and the first common voltage VCOMt is stored in the first liquid crystal capacitor CLCt. The first pixel voltage VPt may be a pixel voltage VDP stored in the first liquid crystal capacitor CLCt.

The source driving unit 670 then outputs the data voltage 1L_{—}0 of the first horizontal line. The gate circuit unit 630 generates a second gate signal G1r of the first horizontal line during a latter H/2 period of the 1H period. In addition, the voltage generating part 615 applies the second common voltage VCOMr to the common electrode of the upper substrate. The voltage generating part 615 applies a fourth common voltage VSTGr to the storage common electrode of the lower substrate. The fourth common voltage VSTGr has a substantially same level as the second common voltage VCOMr.

That is, the first switching element TFTt of the transmitting portion Pt is turned off, and the second switching element TFTr of the reflecting portion Pr is turned on during the latter H/2 period.

Thus, the second switching element TFTr of the reflecting portion Pr is turned on based on the second gate signal G1r to apply the data voltage from the source line DL to the cell capacitor Cc that is electrically connected to the second liquid crystal capacitor CLCr, in serial. A portion VD1 of the data voltage is stored in the cell capacitor Cc, and a remaining portion VD2 of the data voltage is stored in the second liquid crystal capacitor CLCr. The second common voltage VCOMr is applied to the common electrode of the upper substrate 620 that is a second electrode of the second liquid crystal capacitor CLCr.

A second pixel voltage VPr corresponding to a voltage difference between the second common voltage VCOMr and the remaining portion VD2 of the data voltage is stored in the second liquid crystal capacitor CLCr of the reflecting portion Pr. The second pixel voltage VPr may be a pixel voltage VDP stored in the second liquid crystal capacitor CLCr. That is, the data voltage having a level corresponding to the first pixel voltage VPt is divided by the cell capacitor Cc so that the second pixel voltage VPr having a smaller level than the first pixel voltage VPt is stored in the second liquid crystal capacitor CLCr.

In addition, a voltage difference ΔV between the first common voltage VCOMt applied to the first liquid crystal capacitor CLCt during the operation of the transmitting portion Pt and the second common voltage VCOMr applied to the second liquid crystal capacitor CLCr during the operation of the reflecting portion Pr is adjusted to compensate an offset value of the adjusted V-T and V-R curves. The V-T and V-R curves are adjusted by the cell capacitor Cc.

Therefore, the cell capacitor Cc and the common voltage VCOM are both adjusted so that the V-T curve is substantially the same as the V-R curve.

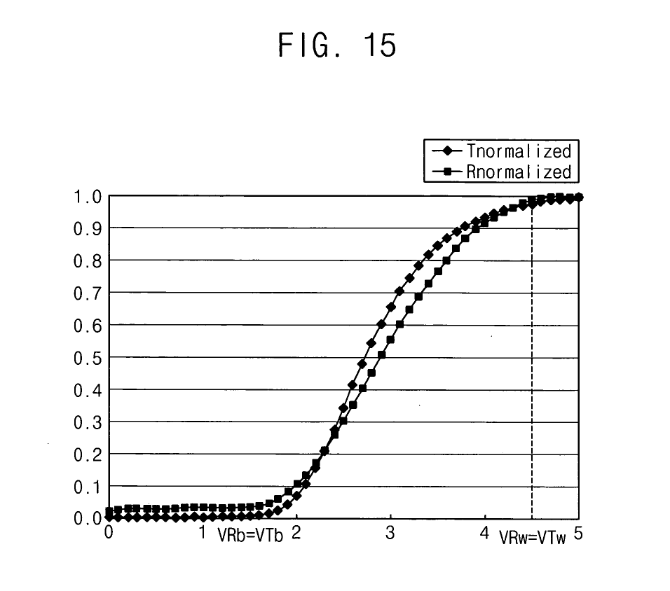

FIG. 15 is a graph illustrating a V-T curve and a V-R curve of an exemplary LCD device in accordance with another exemplary embodiment of the present invention.

Referring to FIGS. 12 and 15, a capacitance of the cell capacitor Cc that is electrically connected to the second liquid crystal capacitor CLCr of the reflecting portion Pr, in serial, is adjusted so that a difference between a white voltage VRw and a black voltage VRb of the V-R curve is substantially the same as a difference between a white voltage VTw and a black voltage VTb of the V-T curve.

In addition, the first common voltage VCOMt applied to the first liquid crystal capacitor CLCt of the transmitting portion Pt and the second common voltage VCOMr applied to the second liquid crystal capacitor CLCr of the reflecting portion Pr are adjusted to compensate the offset value of the adjusted V-T and V-R curves that have the substantially same white and black voltages.

In FIGS. 12 and 15, in an exemplary embodiment, a dielectric constant of the liquid crystal layer corresponding to the data voltage of the transmission mode is compared with a dielectric constant of the liquid crystal layer corresponding to the data voltage of the reflection mode to determine the second common voltage VCOMr.

According to the present invention, a difference between the first common voltage applied to the first liquid crystal capacitor of the transmitting portion and the second common voltage applied to the second liquid crystal capacitor of the reflecting portion is changed by a difference between the peak voltage of the V-T curve and the peak voltage of the V-R curve, thereby improving an image display quality.

In addition, the capacitance of a cell capacitor electrically connected to the second liquid crystal capacitor of the reflecting portion, in serial, is adjusted so that a difference between the white and black voltages of the transmitting mode is substantially the same as a difference between the white and black voltages of the reflecting mode. Furthermore, the level of the common voltage applied to the liquid crystal capacitor is changed to compensate the offset value of the adjusted V-T curve and the V-R curve that are adjusted by the cell capacitor. Thus, the V-T curve has substantially the same shape as the V-R curve to improve the image display quality of the transflective LCD device.

This invention has been described with reference to exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A liquid crystal display device comprising:
a liquid crystal display panel including a plurality of pixel parts, each of the pixel parts including:
a transmitting portion having a first switching element electrically connected to a first gate line, and a first liquid crystal capacitor electrically connected to the first switching element; and
a reflecting portion having a second switching element electrically connected to a second gate line, and a second liquid crystal capacitor electrically connected to the second switching element; and
a driving module applying a first common voltage to the first liquid crystal capacitor during turning-on of the first switching element, and applying a second common voltage to the second liquid crystal capacitor during turning-on of the second switching element.

2. The liquid crystal display device of claim 1, wherein the first and second liquid crystal capacitors comprise a liquid crystal layer, and a voltage difference between the first and second common voltages is substantially same as a voltage difference between a peak voltage of a voltage-light transmittance curve of the liquid crystal layer and a peak voltage of a voltage-light reflectivity curve of the liquid crystal layer.

3. The liquid crystal display device of claim 2, wherein the liquid crystal layer comprises a vertical alignment mode.

4. The liquid crystal display device of claim 1, wherein the first switching element comprises:
a first gate electrode electrically connected to the first gate line;
a first source electrode electrically connected to a source line; and
a first drain electrode electrically connected to a transparent electrode, the transparent electrode being a first electrode of the first liquid crystal capacitor.

5. The liquid crystal display device of claim 4, wherein the second switching element comprises:
a second gate electrode electrically connected to the second gate line adjacent to the first gate line;
a second source electrode electrically connected to the source line; and
a second drain electrode electrically connected to a reflecting electrode, the reflecting electrode being a first electrode of the second liquid crystal capacitor.

6. The liquid crystal display device of claim 5, wherein a first common electrode of the first liquid crystal capacitor is electrically connected to a second common electrode of the second liquid crystal capacitor.

7. The liquid crystal display device of claim 5, wherein the driving module comprises:
a source driving unit applying a data voltage to the source line;
a gate driving unit outputting a first gate signal and a second gate signal activating the first and second gate lines, respectively; and
a voltage generating unit applying the first common voltage to the first liquid crystal capacitor during activation of the first gate line, and applying the second common voltage to the second liquid crystal capacitor during deactivation of the first gate line and activation of the second gate line.

8. The liquid crystal display device of claim 7, wherein the first gate line is activated during an initial H/2 period of a 1H period, and the second gate line is activated during a latter H/2 period of the 1H period.

9. The liquid crystal display device of claim 7, wherein the first gate line is activated during an initial H/2 period of a 1H period, and the second gate line is activated during an entire period of the 1H period.

10. The liquid crystal display device of claim 1, further comprising a liquid crystal layer, wherein the second common voltage is determined by comparing a dielectric constant of the liquid crystal layer in a transmission mode with a dielectric constant of the liquid crystal layer in a reflection mode.

11. The liquid crystal display device of 1, wherein an absolute value of the first common voltage is greater than an absolute value of the second common voltage.

12. A driving module for driving a liquid crystal display device including a plurality of pixel parts, each of the pixel parts including a transmitting portion having a first switching element electrically connected to a first gate line and a first liquid crystal capacitor electrically connected to the first switching element, and a reflecting portion having a second switching element electrically connected to a second gate line and a second liquid crystal capacitor electrically connected to the second switching element, the driving module comprising:
a gate driving unit outputting a first gate signal and a second gate signal activating the first and second gate lines, respectively; and
a voltage generating unit applying the first common voltage to the first liquid crystal capacitor during activation of the first gate line, and applying the second common voltage to the second liquid crystal capacitor during a deactivation of the first gate line.

13. The driving module of claim 12, wherein the first and second liquid crystal capacitors comprise a liquid crystal layer, and a voltage difference between the first and second common voltages is substantially same as a voltage difference between a peak voltage of a voltage-light transmittance curve of the liquid crystal layer and a peak voltage of a voltage-light reflectivity curve of the liquid crystal layer.

14. A method of driving a liquid crystal display device including a pixel part, the pixel part including a transmitting portion having a first switching element and a first liquid crystal capacitor electrically connected to the first switching element and a reflecting portion having a second switching element and a second liquid crystal capacitor electrically connected to the second switching element, the method comprising:
turning on the first switching element to charge the first liquid crystal capacitor by a first pixel voltage corresponding to a voltage difference between a data voltage from the first switching element and a first common voltage; and
turning off the first switching element and turning on the second switching element to charge the second liquid crystal capacitor by a second pixel voltage corresponding to a voltage difference between a data voltage from the second switching element and a second common voltage.

15. The method of claim 14, wherein the first and second liquid crystal capacitors comprise a liquid crystal layer, and a voltage difference between the first and second common voltages is substantially same as a voltage difference between a peak voltage of a voltage-light transmittance curve of the liquid crystal layer and a peak voltage of a voltage-light reflectivity curve of the liquid crystal layer.

16. The method of claim 14, wherein the first pixel voltage is charged by:
activating a first gate line connected to the first switching element to apply a voltage corresponding to the data voltage from the first switching element to a transparent electrode of the first liquid crystal capacitor; and
applying the first common voltage to a first common electrode of the first liquid crystal capacitor.

17. The method of claim 16, wherein the second pixel voltage is charged by:
deactivating the first gate line;
activating a second gate line connected to the second switching element to apply a voltage corresponding to the data voltage from the second switching element to a reflecting electrode of the second liquid crystal capacitor; and
applying the second common voltage to a second common electrode of the second liquid crystal capacitor.

18. The method of claim 14, wherein a first gate line connected to the first switching element is activated during an initial H/2 period of a 1H period.

19. The method of claim 14, wherein a second gate line connected to the second switching element is activated during a latter H/2 period of a 1H period.

20. The method of claim 14, wherein a second gate line connected to the second switching element is activated during a 1H period.

21. The method of claim 14, wherein the first switching element is turned off at a same time as when the second switching element is turned on.

22. The method of claim 14, wherein the first switching element and the second switching element are substantially simultaneously turned on, and the first switching element is turned off prior to turning off the second switching element.

23. The method of claim 14, wherein the first and second liquid crystal capacitors include a liquid crystal layer, the method further comprising determining the second common voltage by comparing a dielectric constant of the liquid crystal layer in a transmission mode with a dielectric constant of the liquid crystal layer in the reflection mode.

24. A liquid crystal display device comprising:
a liquid crystal display panel including a plurality of pixel parts, each of the pixel parts including:
a transmitting portion having a first switching element electrically connected to a first gate line, and a first liquid crystal capacitor electrically connected to the first switching element; and
a reflecting portion having a second switching element electrically connected to a second gate line, a second liquid crystal capacitor electrically connected to the second switching element, and a cell capacitor electrically connected between the second switching element and the second liquid crystal capacitor; and
a driving module applying a first common voltage to the first liquid crystal capacitor during turning-on of the first switching element, and applying a second common voltage to the second liquid crystal capacitor during turning-on of the second switching element.

25. The liquid crystal display device of claim 24, wherein the transmitting and reflecting portions further comprise a first storage capacitor and a second storage capacitor, respectively, and
the driving module applies the first common voltage to the first storage capacitor during the turning-on of the first switching element, and applies the second common voltage to the second storage capacitor during the turning-on of the second switching element.

26. The liquid crystal display device of claim 25, wherein the driving module applies the second common voltage to the second storage capacitor during the turning off of the first switching element.

27. The liquid crystal display device of claim 24, wherein the first switching element comprises:
a first gate electrode electrically connected to the first gate line;
a first source electrode electrically connected to a source line; and
a first drain electrode electrically connected to a transparent electrode, the transparent electrode being a first electrode of the first liquid crystal capacitor.

28. The liquid crystal display device of claim 27, wherein the second switching element comprises a second gate electrode electrically connected to the second gate line adjacent to the first gate line, a second source electrode electrically connected to the source line, and a second drain electrode electrically connected to a first electrode of the cell capacitor, and
a second electrode of the cell capacitor is electrically connected to a reflecting electrode, the reflecting electrode being a first electrode of the second liquid crystal capacitor.

29. The liquid crystal display device of claim 28, wherein a first common electrode of the first liquid crystal capacitor is electrically connected to a second common electrode of the second liquid crystal capacitor.

30. The liquid crystal display device of claim 28, wherein the driving module comprises:
a source driving unit applying a data voltage to the source line;
a gate driving unit outputting a first gate signal and a second gate signal activating the first and second gate lines, respectively; and
a voltage generating unit applying the first common voltage to the first liquid crystal capacitor during activation of the first gate line, and applying the second common voltage to the second liquid crystal capacitor during deactivation of the first gate line and activation of the second gate line.

31. The liquid crystal display device of claim 30, wherein the first gate line is activated during an initial H/2 period of a 1H period, and the second gate line is activated during a latter H/2 period of the 1H period.

32. The liquid crystal display device of claim 30, wherein the first gate line is activated during an initial H/2 period of a 1H period, and the second gate line is activated during an entire period of the 1H period.

33. A method of driving a liquid crystal display device including a pixel part, the pixel part including a transmitting portion having a first switching element and a first liquid crystal capacitor electrically connected to the first switching element and a reflecting portion having a second switching element, a cell capacitor electrically connected to the second switching element and a second liquid crystal capacitor electrically connected to the cell capacitor, the method comprising:
turning on the first switching element to charge the first liquid crystal capacitor by a first pixel voltage corresponding to a voltage difference between a data voltage from the first switching element and a first common voltage; and
turning off the first switching element and turning on the second switching element to charge the second liquid crystal capacitor by a second pixel voltage corresponding to a voltage difference between a data voltage from the second switching element and a second common voltage.

34. The method of claim 33, wherein the first pixel voltage is charged by:
applying the first common voltage to a first common electrode of the first liquid crystal capacitor; and
activating a first gate line connected to the first switching element to apply the data voltage from the first switching element to a transparent electrode of the first liquid crystal capacitor.

35. The method of claim 34, wherein the second pixel voltage is charged by:
deactivating the first gate line;
applying the second common voltage to a second electrode of the cell capacitor and a second common electrode of the second liquid crystal capacitor;
activating a second gate line connected to the second switching element to apply a portion of the data voltage from the second switching element to a first electrode of the cell capacitor; and
applying a remaining portion of the data voltage from the second switching element to a reflecting electrode of the second liquid crystal capacitor.

36. The method of claim 33, wherein a first gate line connected to the first switching element is activated during an initial H/2 period of a 1H period.

37. The method of claim 33, wherein a second gate line connected to the second switching element is activated during a latter H/2 period of a 1H period.

38. The method of claim 33, wherein a second gate line connected to the second switching element is activated during a 1H period.
